(19) United States
(12) Patent Application Publication
(10) Pub. No.: US 2026/0203762 A1
(43) Pub. Date: Jul. 16, 2026

(54) NEGOTIABLE INSTRUMENT VERIFICATION SYSTEM

(71) Applicant: Raymond Kenneth Ragan, III, Westminster, MD (US)

(72) Inventor: Raymond Kenneth Ragan, III, Westminster, MD (US)

(21) Appl. No.: 19/450,103

(22) Filed: Jan. 15, 2026

Related U.S. Application Data
(60) Provisional application No. 63/745,386, filed on Jan. 15, 2025.

(51) Int. Cl. G06Q 20/40; G06Q 20/04; G06T 7/00

(52) U.S. Cl. CPC G06Q 20/4016; G06Q 20/042; G06T 7/001

(57) ABSTRACT

A method of authenticating a negotiable instrument comprises using a first computing device to capture a first image of a negotiable instrument and transmit the captured first image to an authentication service. A second computing device different from the first computing device is then used to capture a second image of the negotiable instrument. The second computing device transmits the second image to the authentication service. The authentication service compares, using a computer vision module, the first and second images and then generates a confidence match score indicative of a degree of similarity between the first and second images of the negotiable instrument.

### RELATED APPLICATION DATA

This application claims benefit to U.S. Provisional Application No. 63/745,386 entitled Negotiable Instrument Verification System filed on Jan. 15, 2025, the entirety of which is incorporated herein by reference.

### FIELD

The present technology is generally related to computer implemented systems and methods for securing and authenticating negotiable instruments using computer vision and machine learning.

### BACKGROUND

A negotiable transaction may involve (1) a payor, (2) a payee, and (3) one or more financial intermediaries, such banks, clearinghouses, or other similar financial institutions. A negotiable instrument, like a check, contains information about all parties involved in the transaction and is used as a payment tool that enables the financial institution to move funds between accounts- crediting the payee's account and debiting the payor's account.

In existing systems, the payor's handwritten signature generally serves as the primary indicator of the document's authenticity and the accuracy of its contents. Handwritten signatures, however, are frequently inaccurate, and many financial clerks cannot reliably identify a forged signature without undergoing the necessary fraud detection training. Moreover, current electronic systems have not yet reached a level of sophistication where they can consistently and accurately detect forged signatures. Even when a signature is genuine, it remains relatively simple to modify the document after it has been signed, especially in terms of altering the amount or changing the payee's identity. In some cases, an entire check can be fraudulently fabricated, making it challenging to spot any modifications or additions to the negotiable instrument. As such, there is a need for an improved computer-implemented system and process for authenticating negotiable instruments presented by a payor at a financial institution.

### SUMMARY OF THE INVENTION

Some embodiments advantageously provide computer-implemented methods, systems, and apparatuses to secure and authenticate negotiable instruments, such as checks and bank drafts, using computer vision and machine learning.

According to one or more embodiments, the issuer or drafter of a negotiable instrument will use a computing device to capture an image of the negotiable instrument and/or one or more validation documents. The issuer or drafter will then securely transmit the images and associated meta data to an authentication service which will securely hold the imagery and meta data in trust while the negotiable instrument is in circulation. Once the negotiable instrument is presented to a financial institution for negotiation, the financial institution will scan or capture an image of the presented negotiable instrument and then securely communicate with the authentication service to authenticate the negotiable instrument by comparing the financial institution's image of the negotiable instrument that is held in trust to the presented negotiable instrument to generate and issue a confidence match score.

In one or more embodiments, the financial institution may then apply its business rules against the returned results from the authentication service and decide whether to process the presented negotiable instrument.

In one or more embodiments, the financial institution may optionally request additional imagery of the validation document such as government issued identification card and/or one or more other authenticating document(s), and other available meta data. The financial institution then may apply additional business rules with the benefit of the validation document imagery and decide appropriate processing of the negotiable instrument.

According to one or more embodiments, a method of authenticating a negotiable instrument comprises using a first computing device to capture a first image of a negotiable instrument and transmitting the captured first image to an authentication service. A second computing device different from the first computing device is then used to capture a second image of the negotiable instrument. The second computing device transmits the second image to the authentication service. A computer vision module of the authentication service compares the first and second images and then generates a confidence match score indicative of a degree of similarity between the first and second images of the negotiable instrument.

In one aspect, the method further comprises determining, based on whether the confidence match score meets a predetermined threshold, whether to verify the first and second images as being images of the same negotiable instrument; and transmitting the results of the determination by the authentication service to the second computing device.

In another aspect, the method further comprises scanning and capturing a third image, the third image being an image of a validation document taken by the first computing device; transmitting the captured image of the validation document to the authentication service; scanning and capturing a fourth image, the fourth image being an image of the validation document taken by the second computing device; transmitting the fourth image of the validation document to the authentication service; comparing, using a computer vision module of the authentication service, the third and fourth images; and then generating a confidence match score indicative of a degree of similarity between the third and fourth images.

In another aspect, the method further comprises determining, based on the confidence match score associated with the validation document, whether to process the negotiable instrument at the financial institution and, if so, generating and displaying a corresponding user prompt.

In another aspect, the validation document comprises at least one of a driver's license, passport, government ID, and birth certificate.

In another aspect, the first, second, third, and fourth images are encrypted over a secured digital connection that uploads each image to the authentication service.

In another aspect, the method further comprises determining, at the authentication service, whether the first and second images of the negotiable instrument meet a quality threshold and, if not, generating a user prompt to retake at least one of the first and second images of the negotiable instrument.

In another aspect, the method further comprises determining, at the authentication service, whether the third and fourth images of the validation document meet a quality threshold and, if not, generating a user prompt to retake at least one of the third and fourth images of the validation document.

In another aspect, the method further comprises decrypting, at the authentication services, the uploaded first and second images of the negotiable instrument and uploaded third and fourth images of the validation document.

In another aspect, the method further comprises recording, at the authentication service, a record of the negotiable instrument and storing the record in a database of the authentication service.

In another aspect, at least one of the first computing device and second computing device is communication with the authentication service via a cloud-based network.

In another aspect, the first computing device device comprises hardware that includes a photographic device.

According to one or more further embodiment, a system for validating the authenticity of a negotiable instrument presented to a financial institution comprises: a first computing device configured to capture a first image of the negotiable instrument; a second computing device configured to capture a second image of the negotiable instrument; and an authentication service in communication with the first computing device and the second computing device. The authentication service is configured to: receive the first image of a negotiable instrument from the first computing device and securely store the first image in a database; receive the second image of the negotiable instrument from the second computing device; compare the first and second images in their entirety and generate a confidence match score indicate of a degree of similarity between the first and second images; and determine, based on whether the confidence match score meets a predetermined threshold, whether to verify the first and second images as being images of the same negotiable instrument.

In one aspect, the authentication service is further configured to transmit the determination of whether the first and second images are of the same negotiable instrument to the second computing device.

In another aspect, the authentication service is further configured to: receive a third image, the third image being an image of an identity validation document from the first computing device; and receive a fourth image, the fourth image being an image of the identity validation document from the second computing device.

In another aspect, the authentication service is further configured to: compare the third and fourth images and generate a confidence match score indicative of a degree of similarity between the third and fourth images; and determine, based on the whether the confidence match score meets a predetermined threshold, whether to verify the third and fourth images as being images of the same identity validation document.

In another aspect, the authentication service is further configured to transmit the determination of whether the first and second images are of the same identity validation document to the second computing device.

In another aspect, the identity validation document comprises at least one of a driver's license, passport, government ID, and birth certificate.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates the architecture of an exemplary negotiable instrument verification system where a payor presents a negotiable instrument and/or identity validation document to an issuing financial institution, constructed in accordance with principles of the present application;

FIG. 2 illustrates the architecture of an exemplary negotiable instrument verification system where a payor presents a negotiable instrument and/or identity validation document to a receiving financial institution, constructed in accordance with principles of the present application;

FIG. 3 illustrates the architecture of an exemplary authentication service, constructed in accordance with principles of the present application; and

FIG. 4 illustrates the architecture of an exemplary negotiable instrument verification system where the payor transmits the image of the negotiable instrument and/or identity validation document to the authentication service, constructed in accordance with principles of the present application.

### DETAILED DESCRIPTION

The present invention advantageously provides a system and method of securing and authenticating negotiable instruments such as checks and bank drafts using computer vision and machine learning.

As referred to herein, the terms “Issue or Drafter” refer to any financial institution or organization that is involved with the preparation, drafting, and/or issuance of negotiable instruments.

The term “negotiable instrument” refers to a signed, written document promising or ordering an unconditional payment of a specific sum of money, either on demand or at a set future time, to a specific person or to the bearer, making it easily transferable like cash. Key examples include checks, promissory notes, and certificates of deposit (CDs). The negotiable instrument can be traditionally printed and manually signed, computer printed, or fully digital.

The term “identity validation document” refers to any official document, such as a driver's license, passport, state-issued ID card, or birth certificate, issued by a national, state, or local authority to verify a person's identity, age, and sometimes legal status. In some circumstances, validation documents can include security elements such as photos, holograms, unique numbers (e.g., social security numbers), and data for secure identification in various transactions and access control.

The term “financial institution” refers to an organization that provides financial services to clients, acting as an intermediary between savers and borrowers to facilitate the flow of capital in the economy. These institutions manage and transfer money and other financial assets and are subject to regulatory oversight.

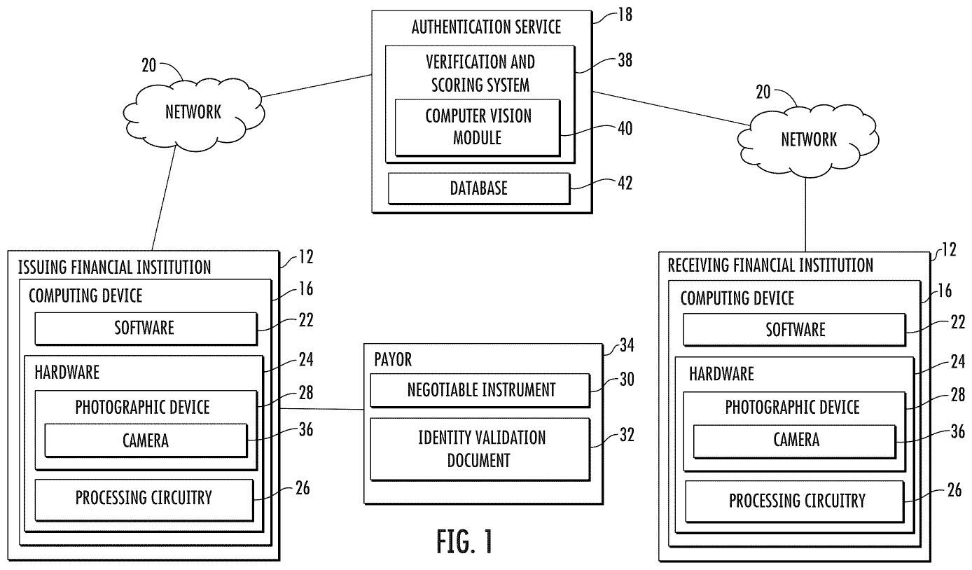

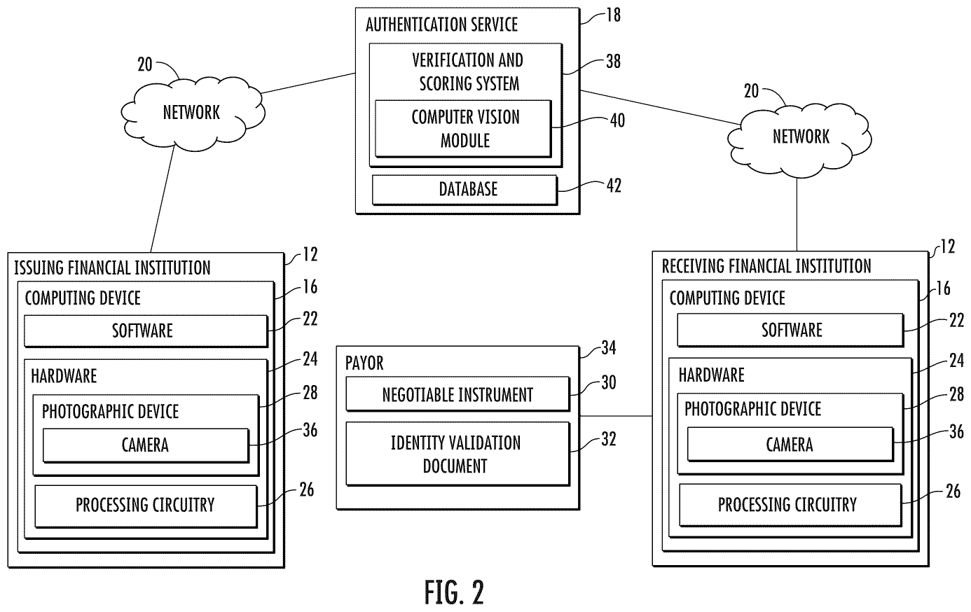

Referring now to the drawing figures in which like reference designations refer to like elements, an example of an exemplary negotiable instrument verification system designated generally herein as “10,” configured in accordance with principles of the present invention as shown in FIGS. 1 and 2. According to one or more embodiments, the system 10 comprises an issuing financial institution 12 and a receiving financial institution 14 that each have their own respective computing device 16. An authentication service 18 acts as an intermediary between the computing devices 16 of the issuing and receiving financial institutions 12, 14. It is to be understood that the authentication service 18 is the host server of an intermediary service business that carries out the negotiable instrument verification and authentication processes of the present system described herein. As shown in FIGS. 1 and 2, the authentication service 18 is in communication with each computing device 16 via one or more networks 20.

Continuing to refer to FIGS. 1 and 2, each financial institution 12, 14 comprises its own respective computing device 16. Each computing device 14 comprises software 22 and hardware 24 configured to perform and execute the operations, functions, and processing necessary to implement the system and processes described herein. According to one or more embodiments, the hardware 24 may comprise processing circuitry 26 including a processor and a memory in communication with the processor. Additionally, in some embodiments the hardware 24 further comprises a photographic device 28 that is configured to capture one or more images of a financial negotiable instrument 30 and/or any accompanying identity validation document 32 presented when presented by a payor 34 to the financial institution 12, 14. As a non-limiting example, the photographic device 28 comprises a camera 36 configured to capture one or more images of a physical negotiable instrument 30 and any identity validation documents 32.

As mentioned above, the hardware 24 of each computing device 16 may include processing circuitry 26, which may include a processor and a memory. In particular, in addition to or instead of a processor, such as a central processing unit and memory, the processing circuitry 26 may include integrated circuitry for processing and/or control, e.g., one or more processors and/or processor cores and/or FPGAs (Field Programmable Gate Array) and/or ASIC's (Application Specific Integrated Circuitry) adapted to execute instructions. The processor may be configured to access (e.g., write to and/or read from) the memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory may be configured as a storage device.

The processing circuitry 26 may be configured to control any of the methods and/or processes described herein and/or to cause such methods and/or processes to be performed by the one or more server systems. Processor corresponds to one or more processors for performing the one or more server system functions described herein. In some embodiments, the software 22 may include instructions that, when executed by the processor and/or processing circuitry, causes the processor and/or processing circuitry to perform the processes described herein with respect to the one or more server systems.

The software 22 may be stored internally in, for example, memory, or stored in external memory (e.g., database, storage array, network storage device, etc.) and accessible via an external connection. The software may be executable by the processing circuitry 26.

Continuing to refer to FIGS. 1 and 2, according to one or more embodiments the authentication service 18 comprises a verification and scoring system 38 that comprises a computer vision module 40, and a database 42.

Now referring to FIG. 1, at the time of preparing and issuing the negotiable instrument 30 for a payor 34, the issuing financial institution 12 will use its computing device 16 to capture an image of the negotiable instrument 30, and optionally one or more validation document(s) 32 such as a government issued identification card, passport, birth certificate, and/or authorization document, and securely transmit the images and their associated metadata to the authentication service 18 via network 20. The captured image may be of a negotiable instrument 30 that is physical paper, manually signed or printed. According to one or more embodiments, the images of the negotiable instrument and identity validation documents (and their corresponding metadata) can also be entirely digitally synthesized and encrypted over a Transport Layer Security (TLS) secured connection, or other means of digital communication encryption, that transmits the images to the authentication service 18. The authentication service 18 is configured to reply with confirmation of receipt of the images to the issuing financial institution's computing device 16. The authentication service 18 securely holds the imagery and corresponding metadata in trust in database 42 while the negotiable instrument 30 is in circulation between the issuing financial institution 12 and the receiving financial institution 14. As described herein, “metadata” includes any data the authentication service 18 deems accretive to reducing fraud (e.g., location/geospatial data, image hash value, MICR line integrity, biometric data, etc.). As used herein, the term “in circulation” refers to the negotiable instrument being in the payor's physical possession after the issuing financial institution captured the image of the negotiable instrument 30 and now the payor 34 is in transit to present the same negotiable instrument 30 to the receiving financial institution 14.

When the authentication service 18 receives the captured image of the negotiable instrument 30, a secure API call is made to the verification and scoring system 38 of the authentication service 18 that performs quality control processes on the submitted image(s) to decrypt encrypted images and metadata and determine whether the transmitted image of the negotiable instrument 30 and/or validation documents 32 is of sufficient quality. If the image(s) passes quality control (e.g. free of distortion, sufficient line integrity, sufficient contrast, etc.), the digital image (and its associated metadata) is stored and retained in escrow within a server database 42 of the authentication service 18. However, if the image(s) do not pass quality control (including not meeting a predetermined quality threshold), the verification and scoring system 38 can generate and transmit a prompt to the issuing financial institution 12 notifying the issuing financial institution 12 that the submitted image(s) was not of sufficient quality and needs to be resubmitted.

Continuing to refer to FIG. 1, once the issuing financial institution 12 transmits the image of the identity validation document 32 and/or negotiable instrument 30 to the authentication service 18, the payor 34 may then present the physical validation document 32 and/or negotiable instrument 30 at the receiving financial institution 14 (as shown in FIG. 2). As shown in FIG. 2, when the negotiable instrument 30 is presented to the receiving financial institution 14, the computing device 16 of the receiving financial institution 14 will capture a second image of the presented identity validation document 32 and/or negotiable instrument 30 and transmit the captured image(s) to the authentication service 18 for validation. According to one or more embodiments, the receiving financial institution 14 also initiates secure digital communication via network 20 (which is cloud based) with the authentication service 18 when transmitting the images.

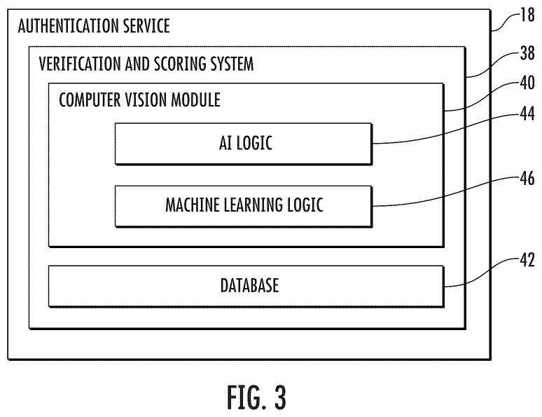

Now referring to FIG. 3, the verification and scoring system 38 of the authentication service 18 comprises the computer vision module 40 that is capable of utilizing artificial intelligence (AI) and machine learning processes, and comprises the necessary hardware, software, and logic (including AI logic 44 and machine learning logic 46), that enables the computer vision module 40 to analyze the images of the identity validation documents 32 and/or negotiable instruments 30 received from each financial institution 12, 14 in their entirety (as opposed to using individual artifacts to determine authenticity), and implement the AI and/or machine learning algorithms to manually or automatically calculate and generate a confidence match score. The computer vision module 40 is capable of reading and analyzing information displayed on the negotiable instrument 30 such as payment amount, payee identity, payor identity, date, etc. Similarly, as a non-limiting example, when the authentication service 18 receives a captured image of the identity validation documents 32, the verification and scoring system 38 uses the computer vision module 40 to read and analyze information displayed on the identity validation documents 32 such as, for example, name, date of birth, address, state, height, picture, unique numbers (such as driver's license numbers, passport numbers, social security numbers, and the like). Notably, the computer vision module 40 is capable of analyzing the negotiable instrument 30 and identity validation documents 32 in their entirety, as opposed to focusing only on individual artifacts. According to one or more embodiments, the computer vision module 40 comprises one or more modules or logic to enable the following processes, functions, and operations: basic image manipulation, fast image comparison, image capture, and image AI.

Additionally, in some embodiments the authentication service 18 can compile metadata and additional available information such as cancellation, paid, or other payment status(es) of the images held in trust by the authentication service 18 and transmit that data and information to the receiving financial institution 14 in the form of an information payload package via the secured TLS connection (or other digital communication encryption). Then the authentication service 18 will then respond through the secured digital connection to the receiving financial institution 14 with the information payload. As referenced to herein, the information payload package comprises the check image, associated metadata (e.g., payment status, check hold information, any stipulations, etc.), and any meta images (e.g., driver's license) associated with the identity validation document and/or negotiable instrument.

The confidence match score is indicative of the likelihood that the images of the validation documents 32 and/or negotiable instruments 30 captured at the receiving financial institution 14 match the images of the validation documents 32 and/or negotiable instruments 30 captured by the issuing financial institution 12 that are being held by the authentication service 18. If the images from each financial institution 12, 14 match, that represents that the documents and instruments presented to the receiving financial institution 14 match those that were prepared and issued by the issuing financial institution 12 (or prepared by the payor 34 and presented to the issuing financial institution 12 for image capture). Thus, a negotiable instrument 30 presented with fraudulently manipulated information will generate a lower confidence match score than a negotiable instrument presented with the authentic information that was on the negotiable instrument when it was initially registered and stored with the authentication service 18. In other words, a higher confidence match score corresponds to a greater likelihood that the captured images match-which indicates that it's likely that the same negotiable instrument was presented at both the issuing and receiving financial institutions 12, 14. According to one or more embodiments, when comparing the respective images to generate the confidence match score, the computer vision module 40 uses AI Logic 44 to perform various operations. For example, when analyzing the image of the negotiable instrument 30 and/or validation document 32, the AI Logic 44 and/or machine learning logic 46 of the computer vision module 40 reads the captured image as a grid of numbers where each number represents a pixel's color as an output of the digitally captured check image. The AI Logic 44 and/or machine learning logic 46 then scans these numbers using mathematical filters to find patterns—starting with simple edges and building up to complex shapes. The AI Logic 44 and/or machine learning logic 46 learns these patterns by studying millions of labeled images (like digital flashcards). Then, when shown a new image, the AI Logic 44 and/or machine learning logic 46 compare the patterns it finds against what it studied to calculate the probability of a match. It is to be understood that the present AI models of the computer vision module 40 are trained to recognize negotiable instruments, so it quickly knows if it's looking at a negotiable instrument image, which is important for initial quality control. Then the AI Logic 44 and/or machine learning logic 46 uses the negotiable instrument image at origination as the “known good image” or “reference image” to compare against the negotiable instrument presented at the receiving financial institution 14 after it circulated. Thus, the AI model implemented by the AI Logic 44 and/or machine learning logic 46 is “trained” on the initial captured image of the negotiable instrument 30, but the second image captured by the receiving financial institution 14 is what it's trying to compare and make the prediction against to verify whether the images are of the same negotiable instrument 30.

As mentioned above, the confidence match score is indicative of the degree of similarity between the first image (or set of images) the authentication service 18 received from the issuing financial institution 12 and the second image (or set of images) received from the receiving financial institution 14. The receiving financial institution will apply its business rules against the returned results from the authentication service 18 and decide whether to process the negotiable instrument 30. If necessary, such as in the event of a confidence match score that does not reach a predetermined threshold, the receiving financial institution 14 may optionally generate and transmit a request to the authentication service 18, through secure means (e.g., TLS over HTTPS connection or other secure digital communication encryption), for additional imagery of the identity validation documents 32 such as government issued identification card and/or one or more other authenticating document(s), and other available meta data. The receiving financial institution 14 then may apply additional business rules with the benefit of the validation document 32 imagery and decide appropriate processing of the negotiable instrument 30. Additionally, the authentication service 18 may also determine, based on whether the confidence match score meets a predetermined threshold, whether to verify the first and second images (and/or the third and fourth images) as being images of the same negotiable instrument/validation document and transmit that result to the receiving financial institution 14 ..

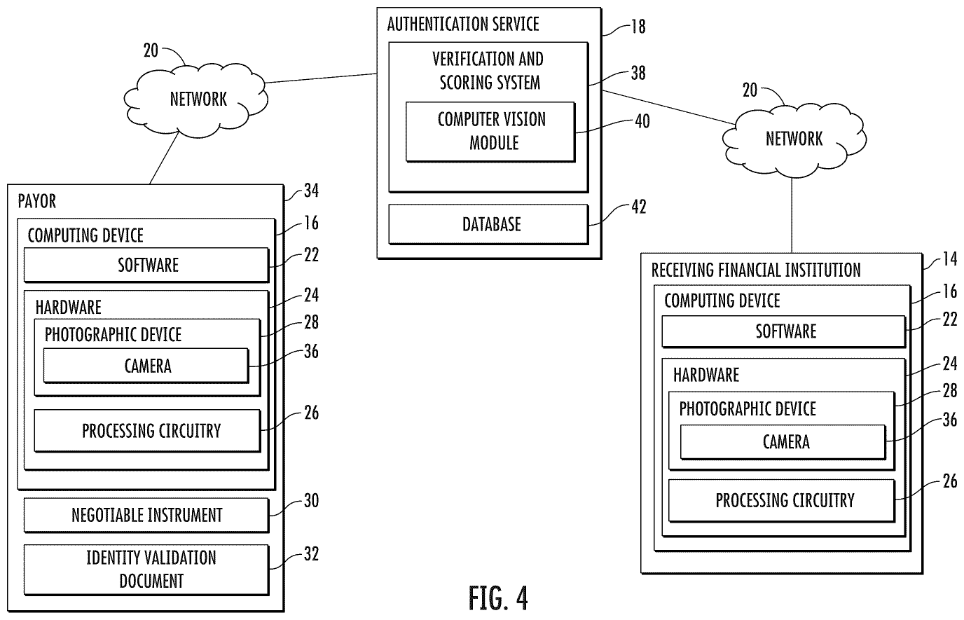

Now referring to FIG. 4, according to one or more embodiments, the system 19 may instead comprise a computing device 16 belonging to payor 34 (e.g., the payor's personal mobile device, tablet, or other smart device) and the computing device 16 belonging to the receiving financial institution 14. The present system 10 also enables payors 34 to capture an image of the physical negotiable instrument 30 using a photographic device 28 that is integrated with hardware 24 of the payor's 34 personal computing device 16. Thus, the present system 10 accounts for situations where the payor 34 themselves prepares a negotiable instrument 30 (e.g., a payor drafting a physical cheque or other negotiable instrument). Using their personal computing device 16, the payor 34 can capture an image of the physical negotiable instrument 30 (and one or more identity validation documents 32), encrypt the image(s), and then transit the image(s) to the authentication service 18. A secure API call to the verification and scoring system 38 of the authentication service 18 that performs quality control processes on the submitted image(s) to determine whether the transmitted image of the negotiable instrument 30 and/or validation documents 32 is of sufficient quality. If the image(s) passes quality control, the digital image (and its associated metadata) is stored and retained in escrow within a server database 42 of the authentication service 18. However, if the image(s) do not pass quality control, the verification and scoring system 38 can generate and transmit a prompt to the payor 34 notifying them that the submitted image was not of sufficient quality and needs to be resubmitted.

The authentication service 18 is configured to reply with confirmation of receipt of the images to the payor's 34 computing device 16. The authentication service 18 securely holds the imagery and corresponding metadata in trust while the negotiable instrument 30 and any validation documents 32 are in circulation between the payor 34 and the receiving financial institution 14.

Once the payor 34 transmits the image of the identity validation document 32 and/or negotiable instrument 30 to the authentication service 18, the payor 34 may then separately present the physical validation document and/or negotiable instrument at the receiving financial institution 14. When the identity validation document 32 and/or negotiable instrument 30 is presented to the receiving financial institution 14, the computing device 16 of the receiving financial institution 14 will capture a second image of the presented identity validation document 32 and/or negotiable instrument 30 and transmit the captured image(s) to the authentication service 18 for validation. According to one or more embodiments, the receiving financial institution 14 initiates secure digital communication via the network 20 (which is cloud-computing based) with the authentication service 18 when transmitting the images.

As previously mentioned, when the authentication service 18 receives the captured image of the negotiable instrument 30 and any validation documents 32 from the receiving financial institution 14, the authentication service 18 utilizes the verification and scoring system 38 to verify whether the images are of sufficient quality. If the image(s) do not pass quality control (including not meeting a predetermined quality threshold), the verification and scoring system 38 can generate and transmit a prompt to the receiving financial institution 14 notifying them that the submitted image was not of sufficient quality and needs to be resubmitted. The computer vision module 40 can also analyze and compare the captured images and the information displayed on the captured images such as payment amount, payee identity, payor identity, date, etc., to the image of the identity validation document 32 and/or negotiable instrument 30 held in escrow by the authentication service 18. The verification and scoring system 38 then utilizes artificial intelligence and/or machine learning processes to calculate a matching score between the two check images. The verification and scoring system 38 then returns a confidence match score to the receiving financial institution 14 indicative of whether the identity validation document and/or negotiable instrument presently being presented by the payor 34 matches the image of the identity validation document 32 and/or negotiable instrument 30 being held in trust at the authentication service 18.

According to one or more embodiments, it is to be understood that verification and scoring system 38 is configured to receive and verify images of the identity validation documents 32 together with the images of the negotiable instruments, or may verify the validation documents 32 at a separate time before or after receipt and/or verification of the negotiable instrument 30 images.

It is to be understood that the photographic device 28 of each computing device 16 further includes an internal photosensitive sensor (Charge-Coupled Device (CCD) or Complementary Metal-Oxide-Semiconductor (CMOS)) that converts the photos reflected from the physical negotiable instrument into digital signals at the time the image of the negotiable instrument is captured. The photographic device 28 is configured to then use the digital signals from the photosensitive sensor to create an image file that is comprised of binary data, that may be used for data manipulation (computer vision and/or Artificial Intelligence), to allow the description to endure when the technology moves past CCD and CMOS sensors.

The present disclosure may be embodied within a system, a method, a computer program product or any combination thereof. In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Having thus described the disclosure of the present application in detail and by reference to embodiments thereof, it will be apparent that modifications and variations are possible without departing from the scope of the disclosure defined in the appended claims as follows:

We claim:

1. A method of authenticating a negotiable instrument, the method comprising:
capturing, using a first computing device, a first image of a negotiable instrument;
transmitting the captured first image of the negotiable instrument to an authentication service;
capturing, using a second computing device, a second image of the negotiable instrument;
transmitting the second image to the authentication service; and
comparing, using a computer vision module of the authentication service, the first and second images of the images of the negotiable instrument and then generating a confidence match score indicative of a degree of similarity between the first and second images captured by each computing device.

2. The method of claim 1, further comprising:
determining, based on whether the confidence match score meets a predetermined threshold, whether to verify the first and second images as being images of the same negotiable instrument; and
transmitting the results of the determination by the authentication service to the second computing device.

3. The method of claim 2, further comprising:
scanning and capturing a third image, the third image being an image of a validation document taken by the first computing device;
transmitting the captured image of the validation document to the authentication service;
scanning and capturing a fourth image, the fourth image being an image of the validation document taken by the second computing device;
transmitting the fourth image of the validation document to the authentication service;
comparing, using a computer vision module of the authentication service, the third and fourth images and then generating a confidence match score indicative of a degree of similarity between the third and fourth images.

4. The method of claim 3, further comprising:
determining, based on the confidence match score associated with the validation document, whether to process the negotiable instrument at a receiving financial institution and, if so, generating and displaying a corresponding prompt to a user of the receiving financial institution.

5. The method of claim 3, wherein the validation document comprises at least one of a driver's license, passport, government ID, and birth certificate.

6. The method of claim 3, wherein the first, second, third, and fourth images are encrypted over a secured digital connection that uploads each image to the authentication service.

7. The method of claim 2, further comprising:
determining, at the authentication service, whether the first and second images of the negotiable instrument meet a quality threshold and, if not, generating a user prompt to retake at least one of the first and second images of the negotiable instrument.

8. The method of claim 4, further comprising:
determining, at the authentication service, whether the third and fourth images of the validation document meet a quality threshold and, if not, generating a user prompt to retake at least one of the third and fourth images of the validation document.

9. The method of claim 6, further comprising:
decrypting, at the authentication service, the uploaded first and second images of the negotiable instrument and uploaded third and fourth images of the validation document.

10. The method of claim 1, further comprising:
recording, at the authentication service, a record of the negotiable instrument and storing the record in a database of the authentication service.

11. The method of claim 1, wherein at least one of the first computing device and second computing device is communication with the authentication service via a cloud-based network.

12. The method of claim 1, wherein the first computing device comprises hardware that includes a photographic device.

13. A system for validating the authenticity of a negotiable instrument presented to a financial institution, the system comprising:
a first computing device configured to capture a first image of the negotiable instrument;
a second computing device configured to capture a second image of the negotiable instrument;
an authentication service in communication with the first computing device and the second computing device; and
wherein the authentication service is configured to:
receive the first image of a negotiable instrument from the first computing device and securely store the first image in a database;
receive the second image of the negotiable instrument from the second computing device;
compare the first and second images in their entirety and generate a confidence match score indicate of a degree of similarity between the first and second images; and
determine, based on whether the confidence match score meets a predetermined threshold, whether to verify the first and second images as being images of the same negotiable instrument.

14. The system of claim 13, wherein the authentication service is further configured to transmit the determination of whether the first and second images are of the same negotiable instrument to the second computing device.

15. The system of claim 13, wherein the authentication service is further configured to:
receive a third image, the third image being an image of an identity validation document from the first computing device; and
receive a fourth image, the fourth image being an image of the identity validation document from the second computing device.

16. The system of claim 15, wherein the authentication service is further configured to:
compare the third and fourth images and generate a confidence match score indicative of a degree of similarity between the third and fourth images; and
determine, based on the whether the confidence match score meets a predetermined threshold, whether to verify the third and fourth images as being images of the same identity validation document.

17. The system of claim 16, wherein the authentication service is further configured to transmit the determination of whether the first and second images are of the same identity validation document to the second computing device.

18. The system of claim 15, wherein the identity validation document comprises at least one of a driver's license, passport, government ID, and birth certificate.
